(19) United States
(12) Patent Application Publication
(10) Pub. No.: US 2004/0062526 A1
(43) Pub. Date: Apr. 1, 2004

(54) VCR manipulation of broadcast digital content

(76) Inventors: Majid Syed, Princeton, NJ (US); Patrick Walsh, Ellicott City, MD (US)

Correspondence Address: Blaney Harper, Jones, Day, Reavis & Pogue, 51 Louisiana Ave., NW, Washington, DC, 20001-2113, US

(21) Appl. No.: 10/261,453

(22) Filed: Oct. 1, 2002

(51) Int. Cl. H04N 5/781

(52) U.S. Cl. 386/83; 386/125

(57) ABSTRACT

“VCR Manipulation of Broadcast Digital Content” Including start of content and end of content indicators in the broadcast data provides for early identification and clean storage and manipulation of broadcast digital content. Thus, a receiver is able to identity a state change (e.g., start of a song or end of a song) and use this information for storing the broadcast content in its entirety. Furthermore, a user is also able to perform VCR-like functions (e.g., like rewind, fast-forward, pause, play) on the broadcast data. TITLE:

### FIELD OF INVENTION

The present invention relates generally to the field of broadcasting. More specifically, the present invention is related to storage and manipulation of digital broadcast content.

### BACKGROUND OF THE INVENTION

Prior art systems exist that allow for the manipulation of digital content that is broadcast to various digital receiver end-devices. One problem associated with storage of broadcast data in such prior art systems is that the system is not pre-warned about the starting or stopping points of a broadcast. This is especially a problem for a user who is interested in storing the content of a particular broadcast segment, as failure to provide for such warnings causes unclean storage of songs. For example, in a radio broadcasting system, a receiver does not have information as to when a song is about to begin (or information regarding when a broadcast song is about to stop). Thus, without such information, a receiver (capable of storing broadcast content) is not able to store the song in its entirety, i.e., from start to finish.

If users are interested and request storage of a particular segment of the broadcast, the receiver starts storing the segment, but only after an initial delay. This often results in storage that is not clean as there is a good chance for the receiver to miss parts of a broadcast due to the delay between the start of a transmission of a segment and manual intervention indicating intent for recording such a segment.

As mentioned earlier, this is especially an inconvenience if the receiver is capable of performing VCR-like functions on the stored segment. For example, if a user indicates to the receiver an interest in the broadcast segment and at a later point in time if the user wants to perform a rewind on the broadcast content, unclean storage (as described earlier) can result in rewinding and starting the segment at an improper starting point (caused by the above described delay).

A patent that describes, in general, the prior art in the field of manipulating received content via VCR-like functions is the patent to Ahmad et al. (6,259,441). Ahmad et al. provide a display pause with elastic playback. The invention described in this patent enables the display of an image to be paused, then, at the end of the pause, resumed at an accelerated rate until a time at which the content of the display corresponds to the content that would have been displayed had the image been displayed at the normal display rate without the pause, at which time display of the image at the normal display rate resumes.

A time-line diagram of the functionality of the system described in the above patent is shown in FIG. 1, wherein a download is requested at time=a by a user. At time=b, the user might choose to pause the streamed content, and at a later time=c, the user decides to end the pause. In this instance the system accelerates the download until time=d, after which normal download speed is resumed.

Furthermore, the invention described in this patent can be used with display systems (analog or digital) that display pre-recorded images (such as are found on video or audio cassettes, or video or audio compact discs, for example) or with display systems that display images based upon display data that is only momentarily available to the display system (such as occurs in the display of television or radio broadcasts).

It should be noted that the patent described above allows for receiving streaming data content and performing VCR-like functions on such content in real-time, but the patent fails to provide a mechanism for clean storage of such content by identifying when such transmissions begin or end. Such systems therefore depend on the user to indicate when to start or stop the storage of broadcast content.

### SUMMARY OF THE INVENTION

The present invention provides for a system and method for using VCR-like functions to manipulate broadcast digital data with start and stop indicators, wherein the start and stop indicators are used for the clean storage and retrieval of data. In the preferred embodiment, the broadcast digital data is a series of audio song segments and the start and stop indicators indicate the start and stop of a song. The system of the present invention identifies a state change (e.g., the reception of a start or stop indicator indicating the start or stop of a new song segment) and initiates a trigger for either initiating or ending storage of a broadcast song segment. Also, the present invention provides for a man machine interface (MMI) that allows a user to input VCR-like functions to manipulate the stored broadcast content. In the preferred embodiment, the MMI has an aural and a graphical user interface (GUI). A long circular buffer allows for rendering the broadcast data in real time to the user via the MMI. The VCR-like functions that can be performed in conjunction with the present invention include: rewind, pause, fast forward, or forward to current time-shifted content.

### BRIEF DESCRIPTION OF THE DRAWINGS

FIG. 1 illustrates a prior art system for performing VCR-like functions on streaming data content.

FIG. 2 illustrates a timing diagram showing the present invention's method for using VCR-like functions to manipulate broadcast digital data with start and stop indicators.

FIG. 3 illustrates how a digital receiver interacts with the broadcast data content with start and stop indicators.

FIG. 4 illustrates the preferred embodiment of the man machine interface (MMI) of the present invention.

FIGS. 5a and 5b illustrate a general time-line diagram depicting how the transmitter, receiver, and the MMI interact with each other.

FIG. 6 illustrates a detailed time-line diagram depicting the method associated with the preferred embodiment of the present invention.

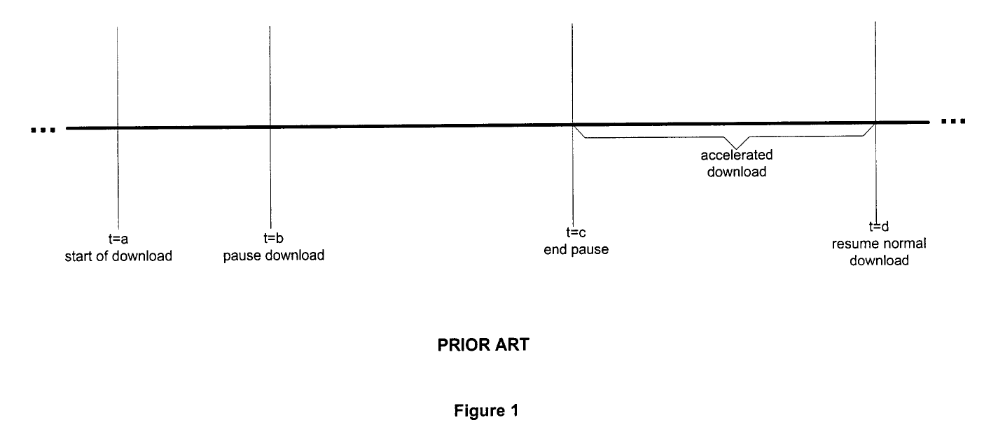

### DESCRIPTION OF THE PREFERRED EMBODIMENTS

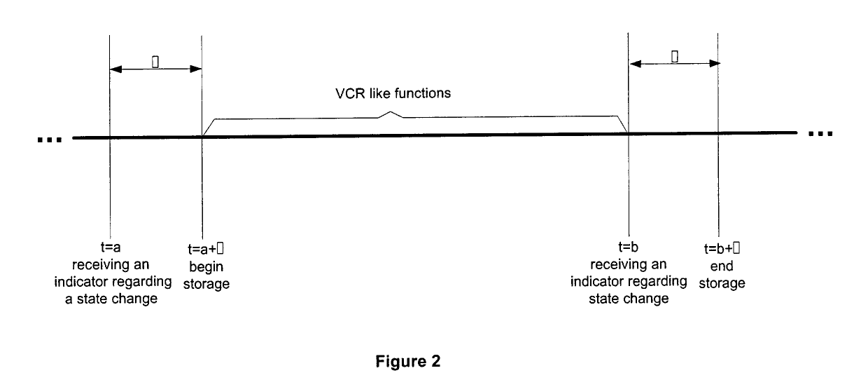

FIG. 2 illustrates a time-line diagram illustrating the present invention's method for digital content storage with start and stop functionality. In this example, at time=a, an indication is received by a digital content receiver regarding an upcoming state change (for example, start of transmission of a song in×seconds). Based upon an input action, at time=a+δ, the received content is allocated for storage. Next, at time=b, another indication is received by the content receiver regarding another upcoming state change (for example, end of transmission of a song in y seconds). After a time interval defined by t=ξ, the storage of the content is stopped. It should be noted that the time intervals shown as ξ and δ are extremely short delays.

In the time interval between time=a+δ and time=b (Δt=b−[a+δ]), VCR-like functions can be performed on the transmitted digital content. The VCR-like functions include, but are not limited to: pause, play, record, rewind, fast-forward, or skip.

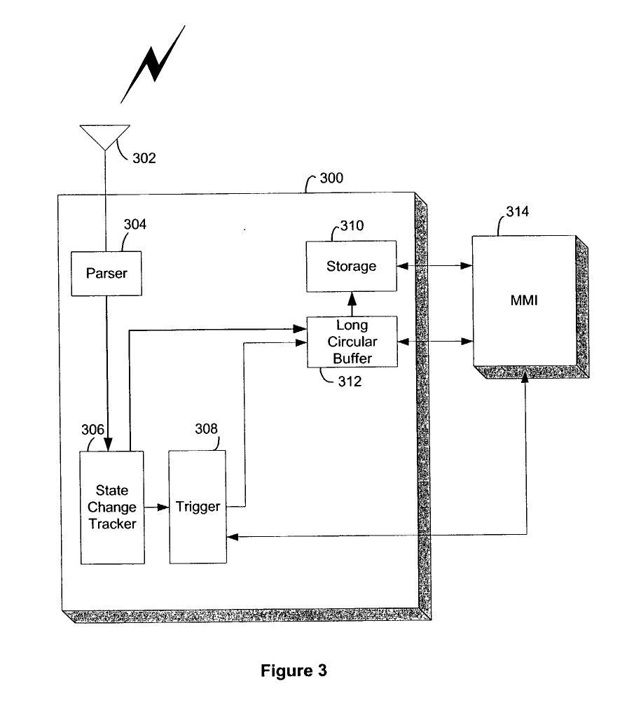

FIG. 3 illustrates how a receiver interacts with the start/stop indicators of the present invention. Receiver 300 receives broadcast data content via antenna 302, and parser 304 parses the data content and identifies any start or stop indicators identifying changes in state that are about to occur. A state change tracker 306 receives information regarding the identified changes in state (start, stop, station ID) and renders information regarding such changes to circular buffer 312. The broadcast content is temporarily stored in circular buffer 312. The start, stop identification is PAC encoded. If a receiver tunes in during the middle of a song, it may not find a start indicator, and therefore is not able to store such songs in their entirety.

In one embodiment, and following along with the same example described in FIG. 2, the start and stop indicators identify the start or stop of a song that is to be broadcast to receiver 300. When trigger 308 is activated by MMI 314 (i.e., listener's desire to store the song), the song is copied into semi-permanent storage 310. The use of start and stop indicators facilitates the copying of the content in its entirety. The MMI 314 may provide features to override the broadcast start/stop indicator. This is useful if the listener is not interested in complete storage, but rather a partial storage of a song that is missing a song start indicator. Additionally, VCR-like functions can either be done on content in time-shifted circular buffer 312 or prior stored content in storage 310.

Start of content and end of content indicators are provided to assist the receiver for multiple applications. These indicators are used by receiver 300 for content storage in its entirety. When a state change in content occurs (for example, start of a song), a message is sent to the tuned receiver 300 about the start of the song. While the preferred embodiment indicates that the receiver and the man machine interface (MMI) are shown as separate entities, the receiver and the MMI can be one entity. Furthermore, the use of a circular buffer in the preferred embodiment is not meant to be limiting in terms of the scope of the present invention, and one skilled in that art can envision using other equivalent buffer systems.

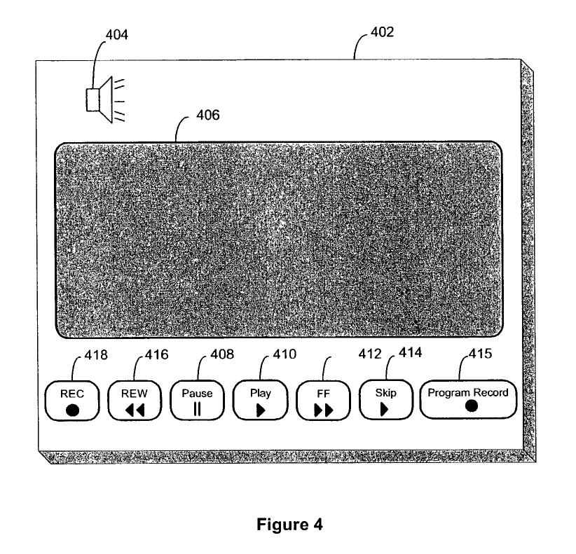

FIG. 4 illustrates an example of an MMI 402. The MMI primary consists of an aural interface 404, a visual interface 406, and a series of buttons for specific commands defining how the rendered content is to be manipulated. The buttons perform various functions including, but not limited to: record 418, rewind 416, pause 408, play 410, fast-forward 412, skip 414, or program record 415.

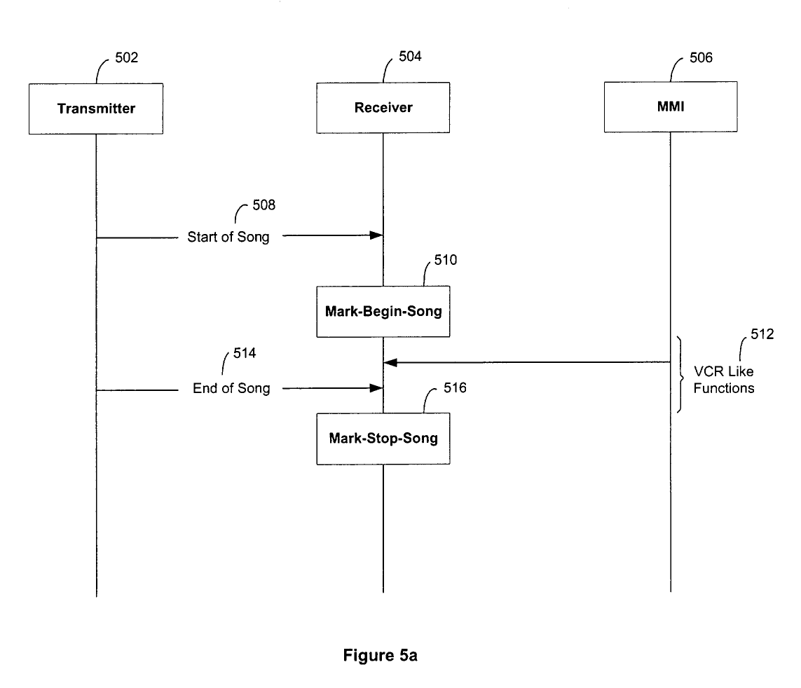

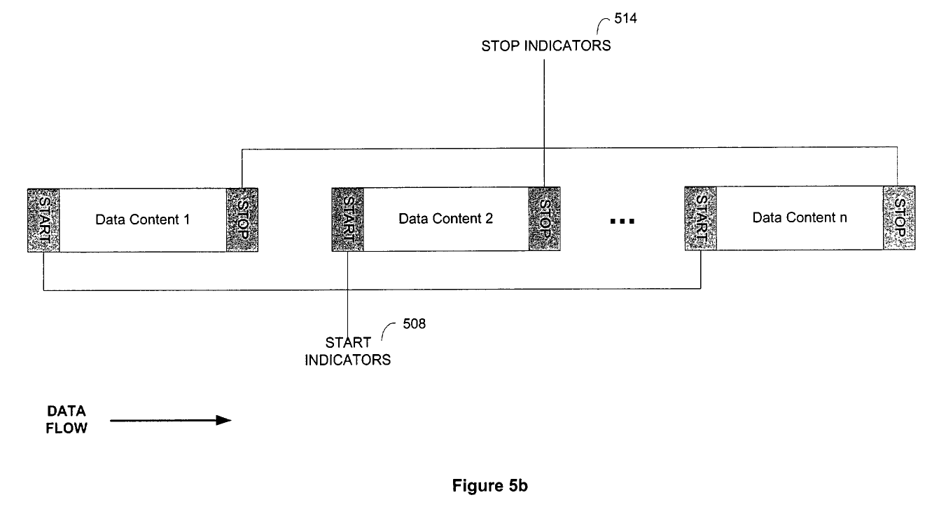

FIG. 5a illustrates a simple time-line diagram depicting how the transmitter 502, receiver 504, and the MMI interface 506 interact with each other. As mentioned earlier, the transmitter 502 streams data that is intercepted by the receiver 504. The streamed data content includes start and stop indicators at the beginning and end of each individual segment (for example, a start and stop indicator at the beginning and end of each song). This aspect is illustrated in FIG. 5b, wherein every segment such as a song is flanked by start 508 and stop 514 indicators.

Returning to the discussion of FIG. 5a, the encoder generated start of song indicator 508 triggers the receiver 504 to mark-begin-song 510, and encoder generated end of song indicator 514 triggers the receiver 504 to mark-stop-song 516. A user is able to perform VCR-like functions 512 while the song is being stored.

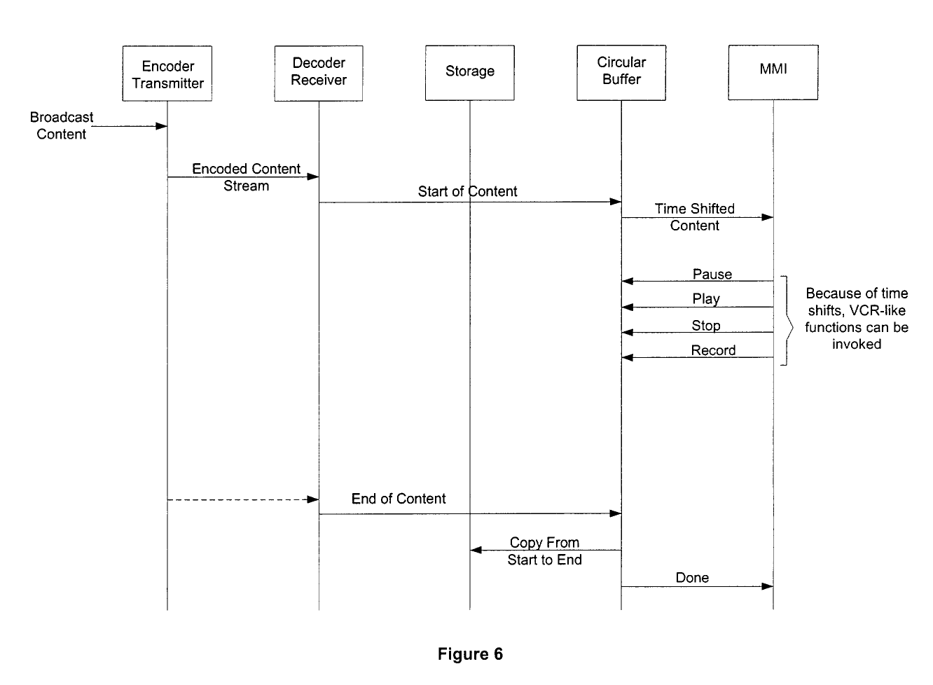

At the receiver end, during the start and end of a song, a time shift may be invoked, i.e., audible song is rendered after Δt. Therefore, should a listener decide to perform storage, a command from MMI 506 is transmitted to trigger 308 (FIG. 3) and the content between the start and stop indicators is copied to semi-permanent storage 310 (FIG. 3). FIG. 6 illustrates an overall time line diagram summarizing the method of the present invention. It should be noted that the entirety of the song can be stored in the storage and the user can perform VCR-like functions on such a stored song at a later point in time.

Furthermore, the present invention includes a computer program code based product, which is a storage medium having program code stored therein, which can be used to instruct a computer to perform any of the methods associated with the present invention. The computer storage medium includes any of, but not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory, or data storage devices.

Implemented in computer program code based products are software modules for:

receiving broadcast data; receiving a start of content indicator; triggering one or more storage units to start storing broadcast data; rendering via a interface said stored broadcast data;

receiving a stop of content indicator; triggering one or more storage units to stop storing broadcast data, and receiving inputs from an interface and performing VCR-like functions on stored broadcast data.

A system and method has been shown in the above embodiments for the effective implementation of VCR functions for manipulating broadcast digital content and the use of such indicators for clean storage of content. The above enhancements for icons and its described functional elements may be implemented in various computing environments. For example, the present invention may be implemented on a conventional IBM PC or equivalent, multi-nodal system (e.g., LAN) or networking system (e.g., Internet, WWW, wireless web). All programming, GUIs, display panels and dialog box templates, and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of broadcasting and digital signal processing.

While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by software/program, computing environment, specific computing hardware, type of buffer used in receiver, location of man-machine interface, type of digital content, or type of VCR-like function.

1. A system for identifying start and stop indicators and using said indicators for cleanly storing and retrieving digital broadcast data, said system comprising:
a receiver receiving digital broadcast data, said digital broadcast data comprising one or more segments, each of said segments comprising at least a start of content indicator, data content, and end of content indicator,
one or more storage units capable of storing said received digital broadcast data;
an interface operatively linked to said receiver rendering said stored digital broadcast data, and
said receiver identifying said start or stop of content indicator and triggering said storage units to begin or end storage of data content associated with a segment, and said interface accessing said storage for said stored segment and performing VCR-like functions on said segment.

2. A system for identifying start and stop indicators and using said indicators for cleanly storing and retrieving data, as per claim 1, wherein said receiver is a digital audio broadcast receiver and said segments are song segments.

3. A system for identifying start and stop indicators and using said indicators for cleanly storing and retrieving data, as per claim 1, wherein said VCR-like functions are any of the following: rewind, pause, fast forward, or forward to current time shifted content.

4. A system for identifying start and stop indicators and using said indicators for cleanly storing and retrieving data, as per claim 1, wherein said interface is a combination of an aural and graphical user interface.

5. A system for identifying start and stop indicators and using said indicators for cleanly storing and retrieving data, as per claim 1, wherein said identification of start or stop indicators is done via a state change tracker.

6. A method for identifying start and stop indicators and using said indicators for cleanly storing and retrieving digital broadcast data, said method comprising:
(i) receiving said digital broadcast data;
(ii) receiving at least a start of content indicator;
(iii) triggering one or more storage units to start storing digital broadcast data;
(iv) rendering said stored digital broadcast data via an interface;
(v) receiving instructions for performing VCR-like functions on said stored digital broadcast data;
(vi) executing said received instructions for performing VCR-like functions on said stored digital broadcast data;
(vii) receiving at least a stop of content indicator, and
(viii) triggering one or more storage units to stop storing digital broadcast data.

7. A method for identifying start and stop indicators and using said indicators for cleanly storing and retrieving digital broadcast data, as per claim 6, wherein said VCR-like functions are any of the following: rewind, pause, fast forward, or forward to current time shifted content.

8. A method for identifying start and stop indicators and using said indicators for cleanly storing and retrieving digital broadcast data, as per claim 6, wherein said interface is a combination of an aural and graphical user interface.

9. A method for identifying start and stop indicators and using said indicators for cleanly storing and retrieving digital broadcast data, as per claim 6, wherein said segments are song segments.

10. A method for identifying start and stop of song indicators and using said indicators for cleanly storing and retrieving songs, said method comprising:
(i) receiving digitally broadcast audio data;
(ii) receiving at least a start of song indicator;
(iii) triggering one or more storage units to start storing said song;
(iv) rendering said stored song via an interface;
(v) receiving instructions for performing VCR-like functions on said stored song;
(vi) receiving at least a stop of song indicator, and
(vii) triggering one or more storage units to stop storing said song.

11. A method for identifying start and stop indicators and using said indicators for cleanly storing and retrieving data, as per claim 10, wherein said VCR-like functions are any of the following: rewind, pause, fast forward, or forward to current time shifted content.

12. A method for identifying start and stop indicators and using said indicators for cleanly storing and retrieving data, as per claim 10, wherein said interface is a combination of aural and graphical user interface.

13. An article of manufacture comprising a computer usable medium having computer readable program code embodied therein which identifies start and stop indicators and using said indicators for cleanly storing and retrieving digital broadcast data, said article comprising:
(i) computer readable program code receiving said digital broadcast data;
(ii) computer readable program code receiving at least a start of content indicator;
(iii) computer readable program code triggering one or more storage units to start storing said digital broadcast data;
(iv) computer readable program code rendering via an interface said stored digital broadcast data;
(v) computer readable program code receiving inputs from an interface for performing VCR-like functions on said stored digital broadcast data.
(vi) computer readable program code receiving a stop of content indicator, and
(vii) computer readable program code triggering one or more storage units to stop storing said digital broadcast data.
